(19) United States
(12) Patent Application Publication
(10) Pub. No.: US 2013/0073230 A1
(43) Pub. Date: Mar. 21, 2013

(54) ENERGY DECOMPOSITION CALCULATING APPARATUS AND METHOD THEREFOR, AND COMPUTER-READABLE RECORDING MEDIUM

(71) Applicants: Hisaaki Hatano, Kanagawa-ken (JP); Yoshiyuki Sakamaki, Kanagawa-ken (JP)

(72) Inventors: Hisaaki Hatano, Kanagawa-ken (JP); Yoshiyuki Sakamaki, Kanagawa-ken (JP)

(73) Assignee: KABUSHIKI KAISHA TOSHIBA, Tokyo (JP)

(21) Appl. No.: 13/544,092

(22) Filed: Jul. 9, 2012

(30) Foreign Application Priority Data
Sep. 20, 2011 (JP) 2011-205332

(51) Int. Cl. G06F 19/00

(52) U.S. Cl. 702/60

(57) ABSTRACT

There is provided a decomposition calculating apparatus in which the first storage stores therein a connection configuration of a plurality of elements in an electric power system, the second storage stores therein possible ranges of respective quantities of consumed energy of the elements, the solution region generator develops the ranges of the quantities of consumed energy, in a space formed by axes indicative of the respective quantities of consumed energy of the elements and obtains a solution region being a region common to the ranges of the quantities of consumed energy in the space, the enclosing ball calculator obtains a ball which encloses the solution region and has a smallest radius, and acquires a central coordinate of the ball, and the proportional division determiner determines quantities of consumed energy of the elements to values of the axes corresponding to the central coordinate in the space.

### CROSS REFERENCE TO RELATED APPLICATIONS

This application is based upon and claims the benefit of priority from the prior Japanese Patent Application No. 2011-205332, filed on Sep. 20, 2011, the entire contents of which are incorporated herein by reference.

### FIELD

Embodiments described herein relate to an energy decomposition calculating apparatus and an energy decomposition method as well as a computer-readable recording medium, and relate to, for example, a data processing technique using measurement data obtained by a measuring apparatus.

### BACKGROUND

In consideration of measurement costs, respective values (for example, consumed energies) of measurement target devices are estimated with the use of measurement values obtained by a number of measuring apparatuses, the number being smaller than the number of the measurement target devices. Particularly in the case where the measurement target devices have a hierarchically connected structure, an energy decomposition process is performed. In the energy decomposition process, a measurement value in an upper level is distributed to a plurality of elements in a lower level. The measuring apparatuses and the devices each correspond to an element in an electric power system.

For example, in electric power equipment in a building, an electric power system has a hierarchical structure, and only a quantity of consumed energy up to a given level is measured. It is assumed that a quantity of consumed energy “Q” in an upper level has been measured, two devices 1 and 2 exist below the upper level, and a quantity of consumed energy “Q1” of the device 1 has also been measured. In this case, a quantity of consumed energy “Q2” of the device 2 can be calculated by Q−Q1.

In contrast, in the case where neither “Q1” nor “Q2” has been measured, “Q” needs to be decomposed to the devices 1 and 2. An example conventional calculating method adopted when the devices are air conditioners involves determining a proportion between the air conditioners using a product of rated electric power and operating hours of each air conditioner, to thereby proportionally distribute “Q”.

In this example method, during estimation of the quantity of consumed energy, proportional division/estimation is performed using not the quantity of consumed energy but alternative quantities such as the rated electric power and the operating hours.

The measurement value includes an error resulting from the accuracy of the measuring apparatus itself or the measuring method, but the accuracy of the value can be dealt with through a statistical process.

Unfortunately, for the accuracy of a value that is obtained through proportional division/estimation using such alternative quantities, there is only one possible error analysis using (1) measurement values collected by a measuring apparatus attached temporarily, (2) data separately measured under similar conditions, or (3) data that can be regarded as the measurement value.

### BRIEF DESCRIPTION OF THE DRAWINGS

FIG. 1 are diagrams each illustrating an example of a hierarchical structure of an electric power system;

FIG. 2 are diagrams each illustrating an example of a solution region including solution candidates;

FIG. 3 are diagrams for describing a circle that encloses the solution region;

FIG. 4 is a diagram illustrating an example in which decomposed values are obtained using a smallest enclosing ball;

FIG. 5 is a diagram illustrating an example in which boundaries are added to the example of FIG. 4;

FIG. 6 are diagrams each illustrating a plotted graph, in which a horizontal axis thereof represents a radius and a vertical axis thereof represents coverage;

FIG. 7 is a diagram illustrating a solution region that is filled by grid points at regular intervals;

FIG. 8 is a diagram in which the solution region illustrated in FIG. 4 is three-dimensionally plotted;

FIG. 9 is a diagram illustrating a coverage function that shows the relation between: a radius of a ball having its center at a central point of the smallest enclosing ball; and coverage of the solution region;

FIG. 10 is a diagram illustrating the solution region illustrated in FIG. 5 with the use of grid points;

FIG. 11 is a diagram illustrating two graphs in which relations between the radius and the coverage are plotted for each of the center of the smallest enclosing ball and a proportional division point obtained based on upper bounds, in the solution region illustrated in FIG. 5;

FIG. 12 is a diagram illustrating line segments connecting vertexes of the solution region illustrated in FIG. 6 to a decomposed value point;

FIG. 13 illustrates an example of a hierarchical connection configuration;

FIG. 14 is a diagram illustrating an example of the solution region;

FIG. 15 is a diagram illustrating approximation of the solution region;

FIG. 16 is a diagram illustrating a configuration of a decomposition calculating apparatus according to Embodiment 1;

FIG. 17 is a flow chart illustrating an operation flow of the apparatus of FIG. 16;

FIG. 18 is a diagram illustrating a configuration of a decomposition calculating apparatus according to Embodiment 2;

FIG. 19 is a flow chart illustrating an operation flow according to Embodiment 2;

FIG. 20 is a flow chart illustrating the operation flow according to Embodiment 2;

FIG. 21 is a flow chart illustrating an operation flow according to Embodiment 3;

FIG. 22 is a flow chart illustrating an operation flow according to Embodiment 4;

FIG. 23 is a flow chart illustrating the operation flow according to Embodiment 4;

FIG. 24 is a flow chart illustrating the operation flow according to Embodiment 4;

FIG. 25 is a flow chart illustrating the operation flow according to Embodiment 4;

FIGS. 26A and 26B are flow charts illustrating the operation flow according to Embodiment 4;

FIG. 27 is a flow chart illustrating the operation flow according to Embodiment 4;

FIG. 28 is a flow chart illustrating the operation flow according to Embodiment 4;

FIG. 29 is a flow chart illustrating the operation flow according to Embodiment 4;

FIG. 30 is a diagram illustrating a configuration of an energy decomposition calculating apparatus according to Embodiment 4;

FIG. 31 is a flow chart illustrating an operation flow according to Embodiment 5;

FIG. 32 is a flow chart illustrating the operation flow according to Embodiment 5;

FIG. 33 is a flow chart illustrating the operation flow according to Embodiment 5;

FIG. 34 is a flow chart illustrating the operation flow according to Embodiment 5; and

FIG. 35 is a flow chart illustrating the operation flow according to Embodiment 5.

### DETAILED DESCRIPTION

According to an embodiment, there is provided a decomposition calculating apparatus comprising: a first storage, a second storage, a solution region generator, an enclosing ball calculator, and a decomposition determiner.

The first storage stores therein a connection configuration of a plurality of elements in an electric power system.

The second storage stores therein possible ranges of respective quantities of consumed energy by the elements.

The solution region generator develops the ranges of the quantities of consumed energy, in a space formed by axes indicative of the respective quantities of consumed energy of the elements and obtains a solution region being a region common to the ranges of the quantities of consumed energy in the space.

The enclosing ball calculator obtains a ball which encloses the solution region and has a smallest radius, and acquires a central coordinate of the ball.

The decomposition determiner determines quantities of consumed energy of the elements to values of the axes corresponding to the central coordinate in the space.

Hereinafter, the embodiments will be described with reference to the accompanying drawings.

### Embodiment 1

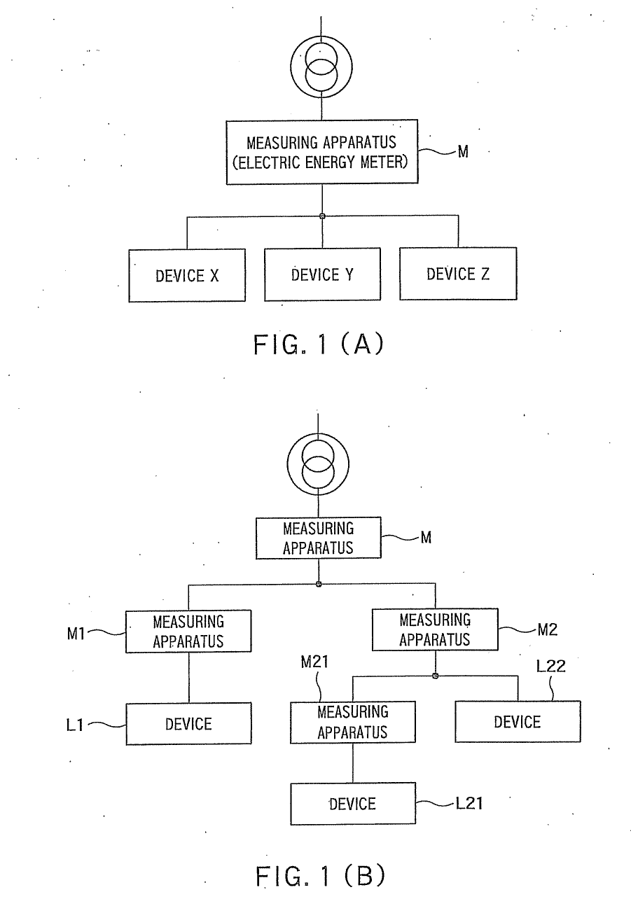

FIG. 1(A) illustrates an example of a hierarchical structure of an electric power system.

Three devices, that is, a device X, a device Y, and a device Z are connected to an electric power system. The total consumed energy of the three devices is measured by a measuring apparatus (electric energy meter) M. The individual consumed energy of each device is not measured. In this case, a method of dividing (or decomposing) the total consumed energy for the devices is discussed.

Assuming that the respective consumed energies of the devices are “X”, “Y”, and “Z” and that a measurement value of the measuring apparatus M is “R”, (X, Y, Z) that satisfies the following expressions is a solution allowable as a division result.

X+Y+Z=R,X≧0,Y≧0,Z≧0 (1-1)

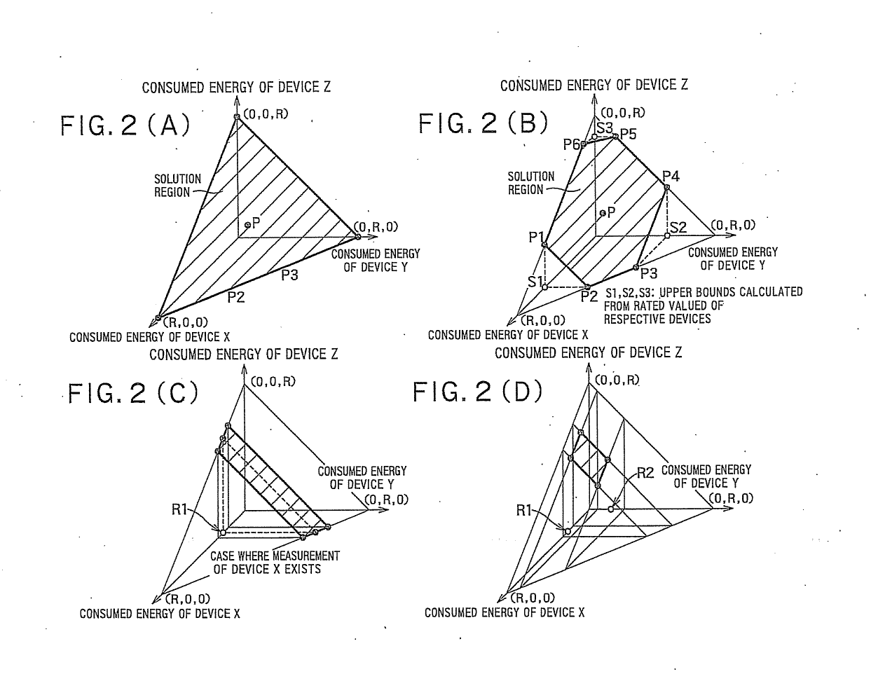

If a range that satisfies Expressions (1-1) is illustrated in a three-dimensional space having coordinate axes that are the respective quantities of consumed energy of the device X, the device Y, and the device Z, a triangle illustrated in FIG. 2(A) is obtained. If there is no information other than the total quantity of consumed energy of the three devices, an entire region of the triangle of FIG. 2(A) is a solution candidate. Obtaining a point P existing in the triangle region corresponds to performing division/estimation. That is, if the point P is obtained, values of “X”, “Y”, and “Z” are determined.

It is assumed that a rated value (maximum power consumption) of each of the devices X, Y, and Z and integrated time of the measuring apparatus are known. Assuming that products of the rated value and the integrated time of the devices X, Y, and Z are “S1”, “S2”, and “S3”, respectively, the following conditions are added on the basis of the fact that the respective quantities of consumed energy of the devices cannot exceed “S1”, “S2”, and “S3”.

X≦S1,Y≦S2,Z≦S3 (1-2)

If the conditions of Expressions (1-1) and Expressions (1-2) are combined with each other, an allowable region of the solution is obtained as illustrated in FIG. 2(B).

Now, it is assumed that the power consumption of the device X is measured and a measurement value “R1” is given. A solution region in this case is as illustrated in FIG. 2(C). In FIG. 2(C), considering a measurement error in the measurement value “R1” of the device X, an allowance of ±“δ1” is provided as in Expression (1-3). Accordingly, the solution region is obtained as an elongated region.

R1−δ1≦X≦R1+δ1 (1-3)

Further, it is assumed that a measurement value “R2” is given also for the device Y. In this case, considering a measurement error, an allowance of ±“δ2” is provided as in Expression (1-4). As a result, the solution region is further narrowed to be obtained as illustrated in FIG. 2(D).

R2−δ2≦Y≦R2+δ2 (1-4)

As a larger amount of information is added in this way, the solution region is more narrowed.

Note that, in the present embodiment, because the number of devices as division targets is three, the solution region is obtained as a planar convex polygon existing in the three-dimensional space. In the case where the number of devices is “n”, the solution region is generally obtained as a convex polyhedron.

In the present embodiment, when the solution region is fixed on the basis of the information thus given, a ball that encloses this region and has the smallest radius, that is, the smallest enclosing ball is obtained, and a central point of the obtained ball is defined as a decomposed value. That is, a value of each axis corresponding to the central point is the decomposed value of each device.

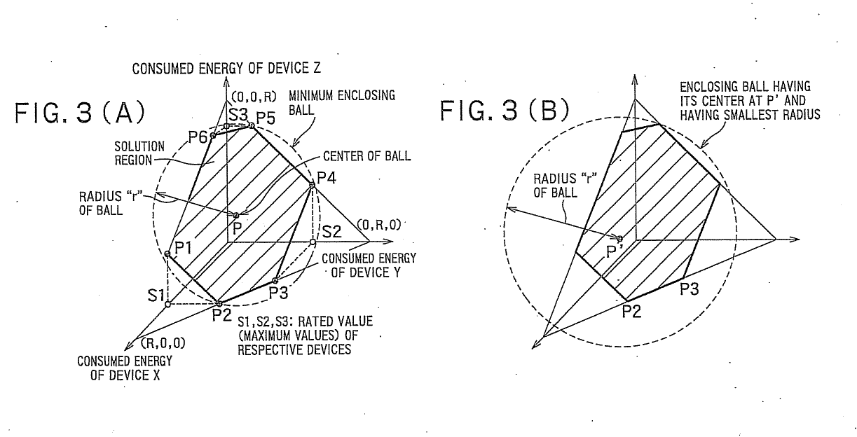

With reference to FIG. 3, a circle that encloses the solution region of FIG. 2(B) is described.

The solution region of FIG. 2(B) is a two-dimensional planar convex polygon, and hence a ball that encloses the region is a circle. When a given point P′ is selected within the solution region, a circle that encloses the entire solution region and has the smallest radius can be drawn with the point P′ as its center (FIG. 3(B)). A radius “r′” of this circle shows that a distance from the point P′ to any point in the region is equal to or less than “r′”. Further, suitable selection of the point P′ can minimize the radius “r′” (FIG. 3(A)). This is the smallest enclosing ball (circle).

Assuming that the radius of the smallest enclosing ball is “r” and that the central point thereof is P, a coordinate of the point P can be defined as a decomposed value. In this case, even if an estimated value deviates to the largest extent in the solution region, the deviation distance is secured to be “r” at most.

Hereinafter, a method of calculating the smallest enclosing ball is described.

In the case where only the total sum R is known, a solution region of division/estimation for “n” devices corresponds to the boundary and the inside of a convex polygon V that satisfies all the following expressions.

R=X1+X2+ . . . +Xn (1-5)

0≦X1≦R, 0≦X2≦R, . . . , 0≦Xn≦R (1-6)

When new information on a device i is added, a possible region of “Xi” is narrowed.

For example, adding a condition that Ri−δ≦Xi≦Ri+δ is discussed. This condition means that portions of Ri−δ>Xi and Ri+δ<Xi are removed from the convex polygon V, and corresponds to cutting away parts of the convex polygon V along a hyperplane defined by Ri−δ=Xi and Ri+δ=Xi. Even if a convex polyhedron is divided along a hyperplane, each divided portion is still a convex polyhedron. Accordingly, a solution space is generally a convex polyhedron.

A ball that encloses a convex polyhedron is coincident with a ball that encloses vertexes of the convex polyhedron. Problems of obtaining the smallest enclosing ball that encloses points in a given “n”-dimensional space are known in fields of computational geometry and optimization. Up to now, some approximation methods have been proposed in, for example, Reference Document 1 and Reference Document 2.

### Reference Document 1. Hamid Zarrabi-Zadeh, Timothy M. Chan: A Simple Streaming Algorithm for Minimum Enclosing Balls, 18^{th} Canadian Conference on Computational Geometry, 2006

### Reference Document 2. Bernd Gaertner: Fast and Robust Smallest Enclosing Balls, Proc. of the 7th Annual European Symposium on Algorithms, 1999

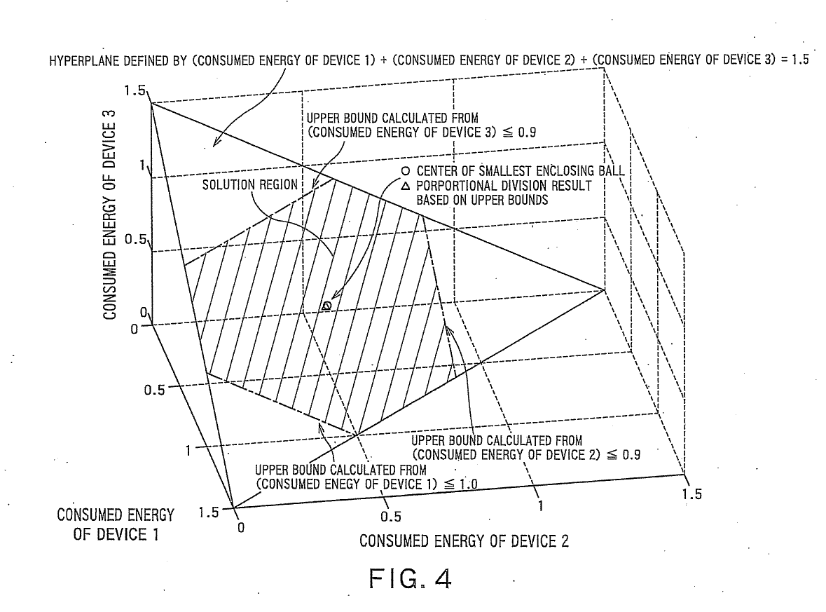

FIG. 4 illustrates an example in which a decomposed value is obtained using the smallest enclosing ball, for three devices, that is, a device 1, a device 2, and a device 3.

In this example, the total quantity of consumed energy is measured as 1.5, and the respective upper and lower boundaries of the consumed energies of the devices are given as follows.

0≦device 1≦1.0

0≦device 2≦0.9

0≦device 3≦0.9

FIG. 4 illustrates a solution region (shaded portion), a center point (circle mark) of the smallest enclosing ball that encloses the solution region, and a proportional distribution point (triangle mark) based on the upper bound values (rated values), under the conditions of the upper and lower boundaries of given above.

The center point of the smallest enclosing ball is (0.5267, 0.4867, 0.4867).

The proportional division point (proportional distribution point) based on the upper boundary values is (0.5357, 0.4821, 0.4821). Here, the proportional division point based on the upper boundary values is obtained by proportionally dividing the total quantity of consumed energy at a proportion of each upper boundary value, assuming that the devices 1, 2, and 3 consume energies of the respective upper boundary values.

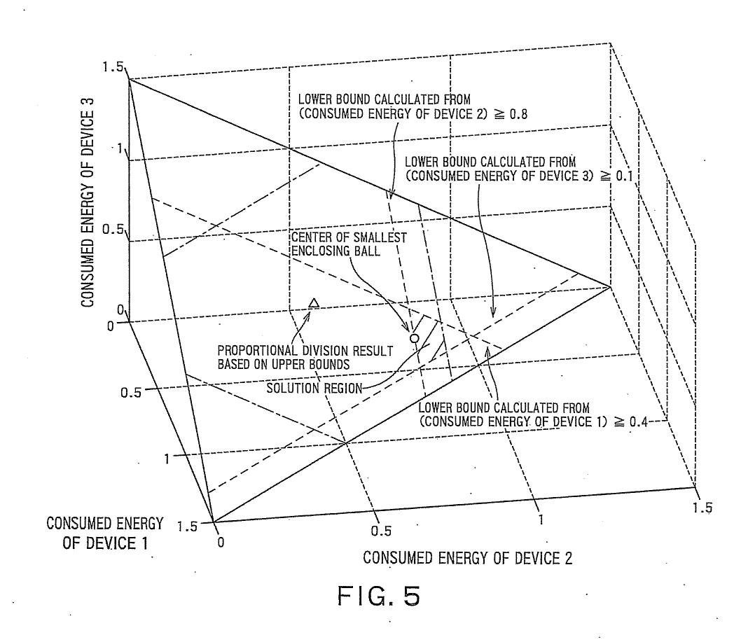

FIG. 5 illustrates a case where conditions are added to the example of FIG. 4.

Specifically, the respective lower bound values of the devices are set to values larger than 0, that is, the following ranges.

0.4≦device 1≦1.0

0.8≦device 2≦0.9

0.1≦device 3≦0.9

FIG. 5 illustrates a solution region, a center point of the smallest enclosing ball, and a proportional distribution point under the conditions given above.

The center point of the smallest enclosing ball is (0.5, 0.8, 0.2).

The proportional distribution point (triangle) based on the upper boundary values exists outside of the solution region. In proportional distribution based on the upper boundary values, the lower boundary values are ignored.

According to the proportional distribution based on the upper boundary values, the obtained consumed energies of the devices 1, 2, and 3 significantly deviate from the solution region. In contrast, according to the method using the smallest enclosing ball of the present embodiment, the obtained consumed energies of the devices 1, 2, and 3 fall within the solution region or do not significantly deviate from the solution region.

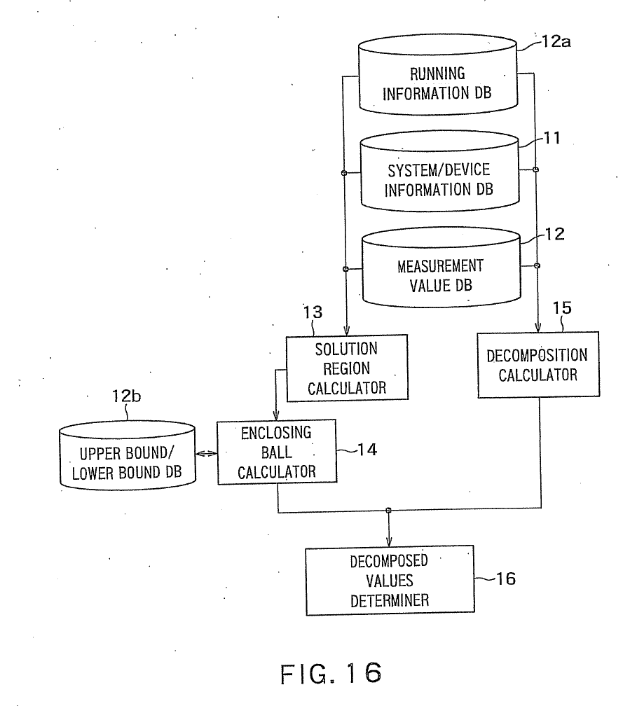

FIG. 16 illustrates a configuration of a decomposition calculating apparatus according to Embodiment 1.

A system/device information (first storage) DB 11 stores therein a connection configuration of a plurality of nodes (the devices, the measuring apparatus) in the electric power system, rating information of each device, and a reading error of the measuring apparatus.

A measurement value (second storage) DB 12 records therein a measurement value of the quantity of consumed energy obtained from the measuring apparatus. Running hours of each device are recorded in a running information DB 12a.

For nodes whose quantity of consumed energy is to be obtained, a solution region generator 13 calculates possible ranges of the respective quantities of consumed energy of the nodes, and records the calculated ranges into an upper bound/lower bound DB 12b. Then, the solution region generator 13 develops the ranges of the quantities of consumed energy of the elements, in a space having the quantities of consumed energy of the elements as its axes. For example, for each device, the lower boundary value and the upper boundary value are calculated for the possible range of the quantity of consumed energy. Simply, the lower boundary value may be 0, and the upper boundary value may be the rated value. For the measuring apparatus, the upper bound and the lower bound may be calculated by reflecting the reading error recorded in the DB 11 in the measurement value recorded in the measurement value DB 12. Alternatively, in the case where the measurement value is missing, the upper bound may be determined by a product of the running history recorded in the running information DB 12a and the rated value recorded in the DB 11. Then, the solution region generator 13 generates, as a solution region, a region common to the ranges of the quantities of consumed energy respectively developed for the nodes. The nodes whose quantity of consumed energy is to be obtained correspond to the devices 1, 2, and 3 in the example given here.

Further, in the case where another condition (for example, the measurement value of the measuring apparatus M is coincident with the total consumed energy of the devices 1, 2, and 3) is added, a range defined by the another condition is developed in the space, and a region also common to this range is obtained as the solution region.

A decomposition calculator 15 calculates the respective quantities of consumed energy of the nodes (for example, the devices, 1, 2, and 3) according to any method (for example, the decomposition based on upper limit values) different from the method using a ball. Note that the decomposition calculator 15 is not an essential element in the present embodiment, and thus may be omitted.

An enclosing ball calculator 14 obtains a ball that encloses the solution region and has the smallest radius, and acquires a central coordinate P of the ball.

A decomposition determiner 16 determines values of the nodes (devices 1, 2, and 3) corresponding to the central coordinate P, as the quantities of consumed energy of the devices 1, 2, and 3.

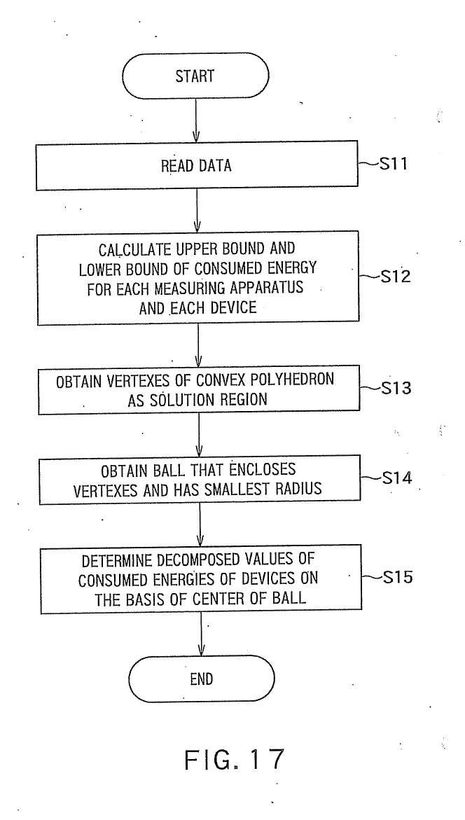

FIG. 17 illustrates an example of an operation flow of the apparatus of FIG. 16.

The solution region generator 13 reads data from a DB such as the system/device information DB 11 (the connection configuration of FIG. 1(A) is assumed here) and the measurement value DB 12 (S11). The solution region generator 13 may also read a condition designated by a user. The condition defines, for example: the consumed energy of which element is to be obtained; and a consumed energy condition concerning the elements (for example, the total consumed energy of the elements is coincident with the measurement value of the measuring apparatus in an upper level).

The solution region generator 13 calculates the upper bound and the lower bound of the consumed energy for each measuring apparatus and each device. Then, for nodes whose quantity of consumed energy is to be obtained (it is assumed here that the devices 1, 2, and 3 are designated as the nodes by the user), the solution region generator 13 develops ranges of the quantities of consumed energy, in a three-dimensional space having the quantities of consumed energy of the devices 1, 2, and 3 as its axes (S12). In addition, the solution region generator 13 develops, into the space, a range defined by a condition that the total consumed energy of the devices 1, 2, and 3 is coincident with the measurement value of the measuring apparatus M.

Vertexes of a convex polyhedron are obtained as a solution region, the convex polyhedron corresponding to a region common to this developed range and the ranges of the quantities of consumed energy respectively developed for the devices 1, 2, and 3 (S13). Specifically, the vertexes of the convex polyhedron as the solution region are obtained.

The enclosing ball calculator 14 obtains a ball that encloses the solution region (vertexes) and has the smallest radius, and acquires a central coordinate of the ball (S14).

The decomposition determiner 16 determines values of the elements (devices 1, 2, and 3) corresponding to the central coordinate, as the quantities of consumed energy of the devices 1, 2, and 3 (S15). That is, the decomposition determiner 16 determines estimation values of the consumed energies of the devices on the basis of the central coordinate of the ball.

In the examples given above, the measuring apparatus exists above the three devices, but this is given as an example, and other connection configurations are possible as a matter of course. For example, as illustrated in FIG. 1(B), one or more measuring apparatuses may exist below a measuring apparatus, and devices may exist further therebelow. M, M1, and M2 each denote a measuring apparatus, and L1 and L21 each denote a device. The plurality of measuring apparatuses M, M1, and M2 are hierarchically connected, and at least one device L1, L21 is connected to the measuring apparatus M1, M21 in the lowermost level.

Also in this case, the consumed energy of each element can be calculated in a stepwise manner using the configuration described above. That is, it is assumed that a measurement value of a given measuring apparatus is correct. Then, on the basis of a condition that the total consumed energy of child (lower-level) elements is coincident with the consumed energy of a parent (upper-level) element, the consumed energy of each element can be obtained level by level toward the lower level and the upper level with reference to the given measuring apparatus as a starting point. This enables consumed energy calculation without a significantly deviating value, for each element in the hierarchical structure. The detail thereof is described in Embodiment 4.

### Embodiment 2

A ball having a radius “r” is drawn with a point P as its center, the point P being given in a solution region. At this time, if “r” is sufficiently large, the entire solution region can be enclosed in the ball. If “r” is small, only part of the solution region can be enclosed in the ball.

Assuming that a portion of the solution region enclosed in the ball occupies “a” percent of the entire solution region, “a” is determined by the given central coordinate P and the radius “r” of the ball. The central coordinate P represents a decomposed value that is determined depending on a type of a decomposition method (a proportional distribution method based on upper boundary values, the method using a ball of Embodiment 1, and other suitable methods).

For example, it is assumed in FIG. 2(B) that the following values are determined using “Si” as a product of a device rated value (maximum power consumption per unit time) and device running hours.

Quantity of consumed energy of device X=(total quantity of consumed energy)×S1/(S1+S2+S3)=R·S1/(S1+S2+S3)

Quantity of consumed energy of device Y=(total quantity of consumed energy)×S2/(S1+S2+S3)=R·S2/(S1+S2+S3)

Quantity of consumed energy of device Z=(total quantity of consumed energy)×S3/(S1+S2+S3)=R·S3/(S1+S2+S3)

In this case, the coordinate of P is (R·S1/(S1+S2+S3), R·S2/(S1+S2+S3), R·S3/(S1+S2+S3)). This corresponds to the proportional distribution method based on the upper boundary values.

In this way, the decomposed value, that is, the point P in the solution region is determined in accordance with the type of the decomposition method. The radius “r” of the ball having its center at the coordinate of the given P and the percentage of a portion of the solution region enclosed in the ball can be potted by setting the radius, to the horizontal axis and the coverage (enclosing rate) to the vertical axis.

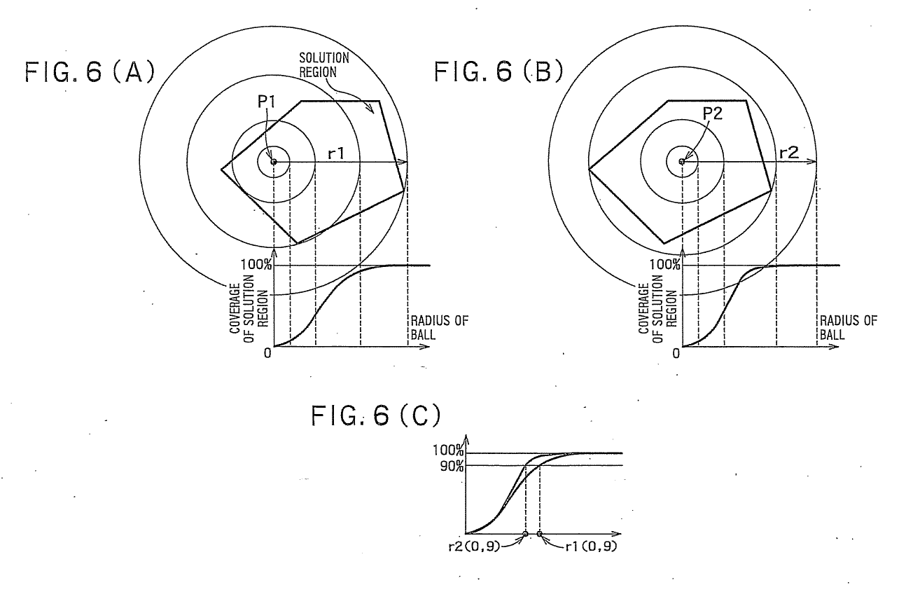

FIGS. 6(A) and 6(B) are plotted graphs, in which a horizontal axis thereof represents a radius and a vertical axis thereof represents coverage. FIG. 6(A) illustrates a case where a decomposed solution P1 exists in a left portion of the solution region, and FIG. 6(B) illustrates a case where a decomposed solution P2 exists near the center of the solution region. When the two graphs are superimposed on each other as illustrated in FIG. 6(C), the graph of FIG. 6(B) is always above the graph of FIG. 6(A), which proves that FIG. 6(B) is superior as the decomposed solution. If the coverage approaches 1 with the radius being still small, the accuracy as a decomposed value can be regarded as higher, but even if the radius when the coverage is 1 is large, the radius when the coverage reaches 0.9 (90%) may be small depending on situations. In such a case, when the coverage of 0.9 is given as a reference, a smaller radius corresponding to the reference can be adopted as a solution. For example, a decomposition solution obtained according to the method of Embodiment 1 is compared with a proportional division solution obtained according to the proportional distribution method based on the upper boundary values, on the basis of the reference, and a superior solution can be selected.

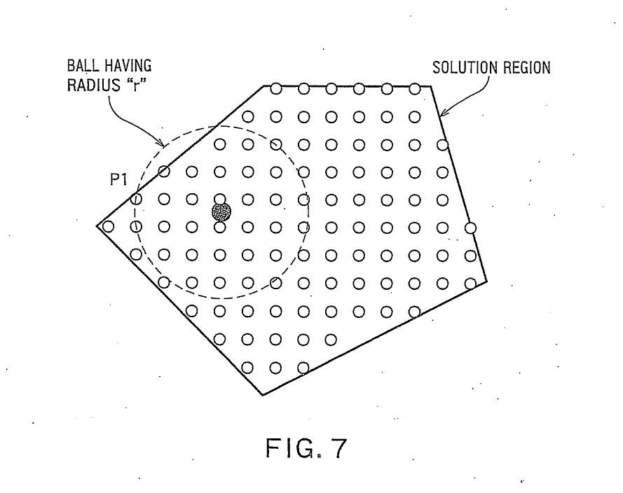

The coverage can be calculated, for example, in the following manner. As illustrated in FIG. 7, with the use of grid points that fill a solution region, a distance of each grid point from the given central coordinate (the decomposed solution P1 is given here as an example) is calculated, and the number of points whose distance therefrom is equal to or less than “r” is divided by the total number of points in the solution region.

The grid points that fill the solution region may be calculated using, for example, a Markov chain Monte Carlo (MCMC) method. Although the coverage can also be calculated by directly obtaining the volume of a convex polyhedron and the volume of a circle having the central coordinate P1 and the radius “r”, in this case, there is a problem that an amount of volume calculation for the convex polyhedron is enormous. According to the method using the grid points, the coverage can be obtained with a smaller amount of calculation.

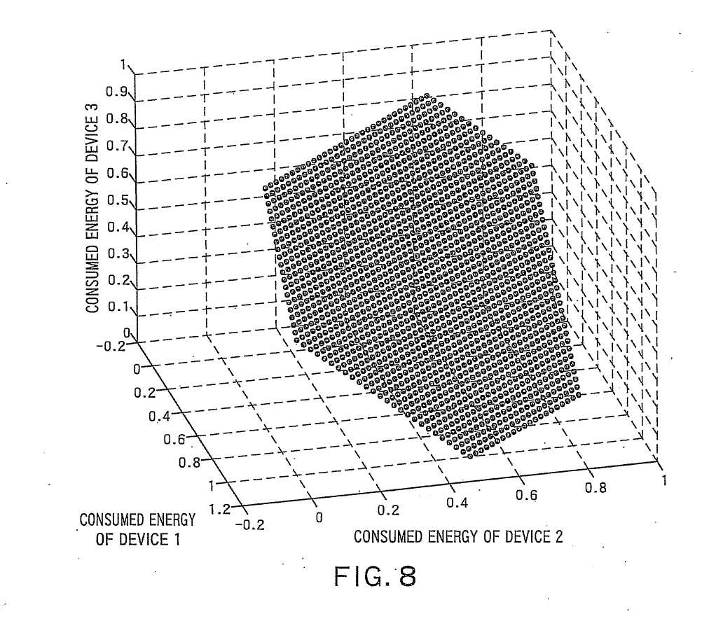

In FIG. 8, the solution region illustrated in FIG. 4 is three-dimensionally plotted. A distance (δ) between grid points is set to 0.02. Note that the detail of the distance between the grid points is described later.

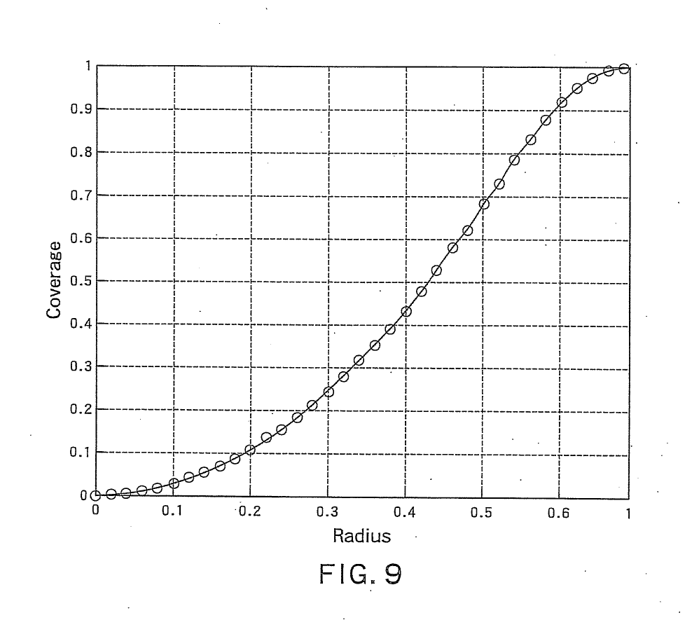

In FIG. 9, a relation between: a radius of a sphere having its center at the central point (circle mark of FIG. 4) of the smallest enclosing ball; and the coverage of the solution region is obtained and plotted.

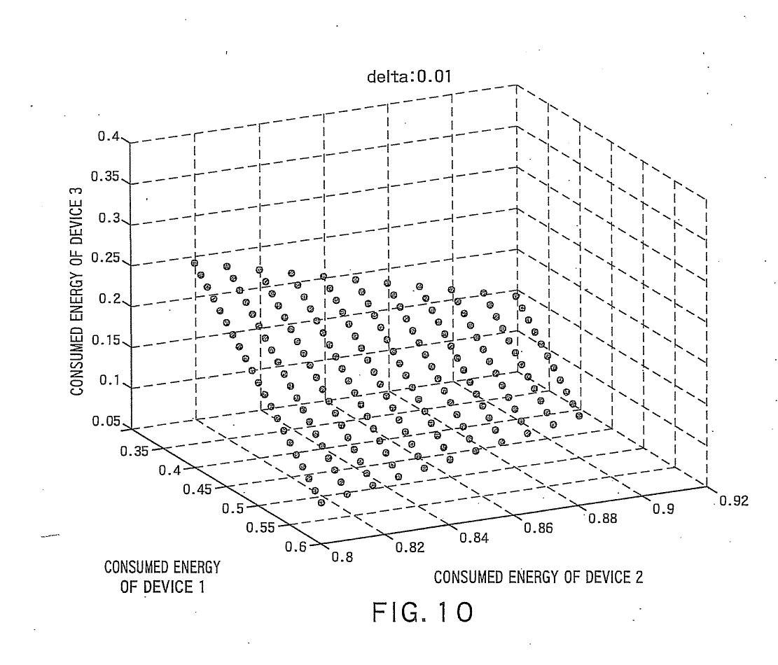

In FIG. 10, the solution region illustrated in FIG. 5 is obtained with the distance “δ” between the grid points being set to 0.01.

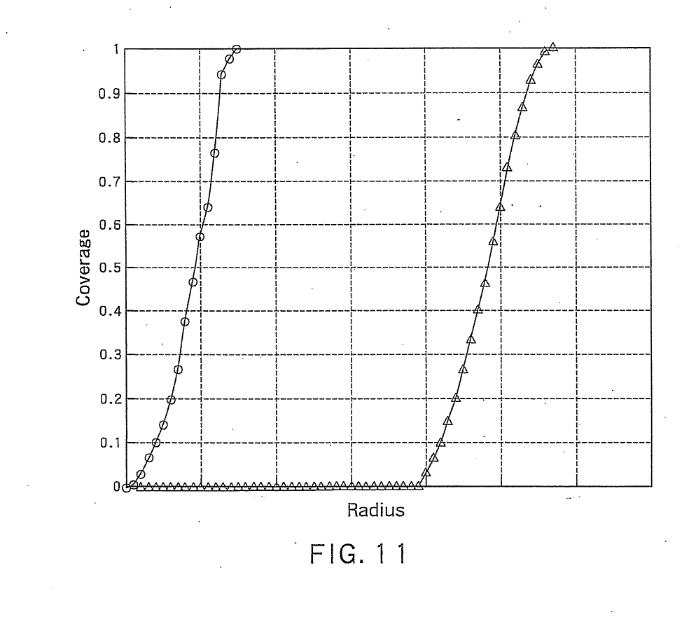

In a graph of FIG. 11, the radius and the coverage are plotted for each of the center (circle mark) of the smallest enclosing ball and the proportional division point (triangle mark) based on the upper boundaries, in the solution region illustrated in FIG. 5. The proportional division point based on the upper bounds does not exist in the solution region, and hence even if the radius is made larger, the coverage remains 0 in the beginning. As described above, if the coverage approaches 1 with the radius being still small, the accuracy as a decomposed value can be regarded as higher. Hence, in the example of FIG. 10, the center of the smallest enclosing ball is obviously superior as a decomposed value.

The use of the present embodiment enables decomposition calculation with an extremely deviating value excluded. That is, a relation between a radius and coverage is calculated according to the method using the smallest enclosing ball, and a relation between a radius and coverage is calculated according to another any method (for example, the proportional division method based on upper bounds). Then, among these two methods, a decomposed value according to one method that provides a smaller radius when the coverage has a predetermined value (for example, 90%) is adopted, whereby the possibility of a significantly deviating value can be further reduced.

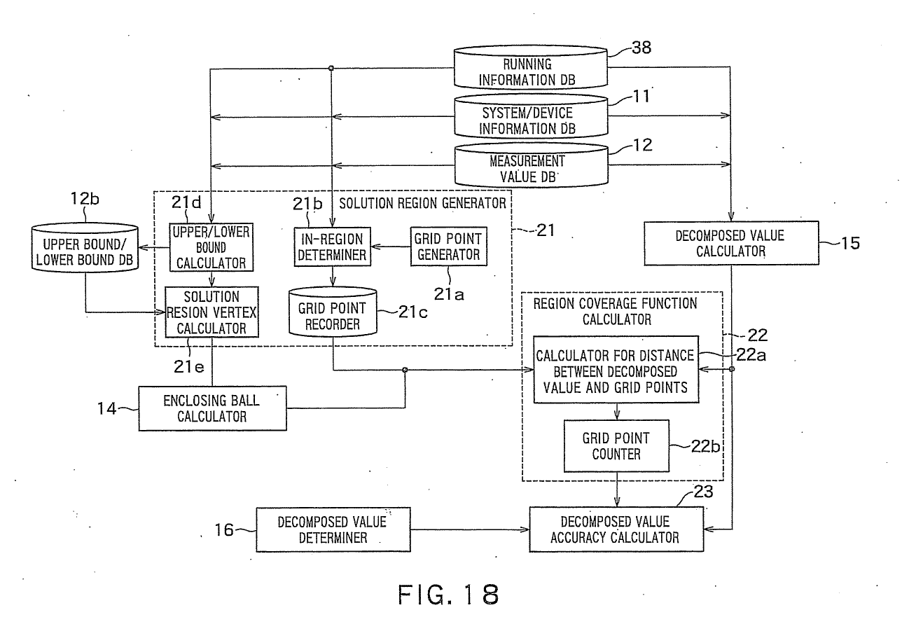

FIG. 18 illustrates a configuration of a decomposition calculating apparatus according to Embodiment 2. Description overlapping with that in Embodiment 1 is omitted. A covering relation calculator 25 (a region coverage function calculator 22 and a decomposition accuracy calculator 23) is added, and an operation of the solution region generator 21 is partially extended. An upper/lower bound calculator 21d and a solution region vertex calculator 21e respectively calculate upper and lower boundary values and vertexes similarly to Embodiment 1. An in-region determiner 21b, a grid point generator 21a, and a grid point recorder 21c are newly provided.

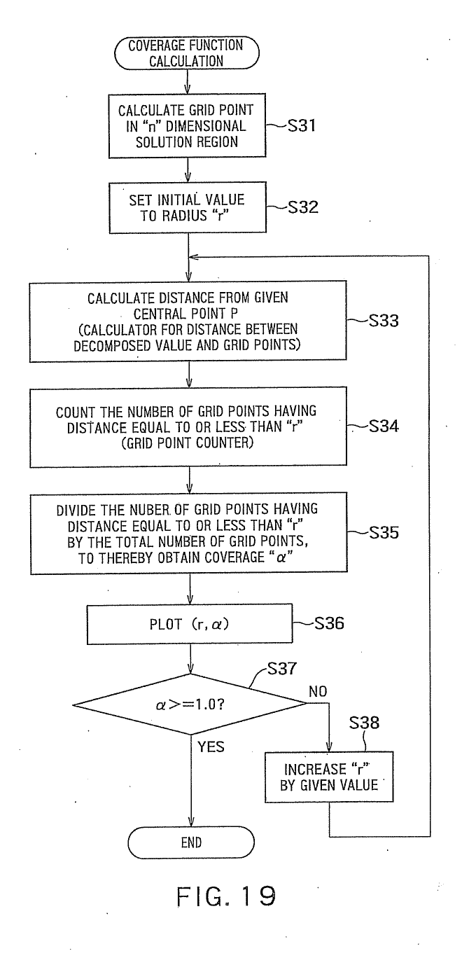

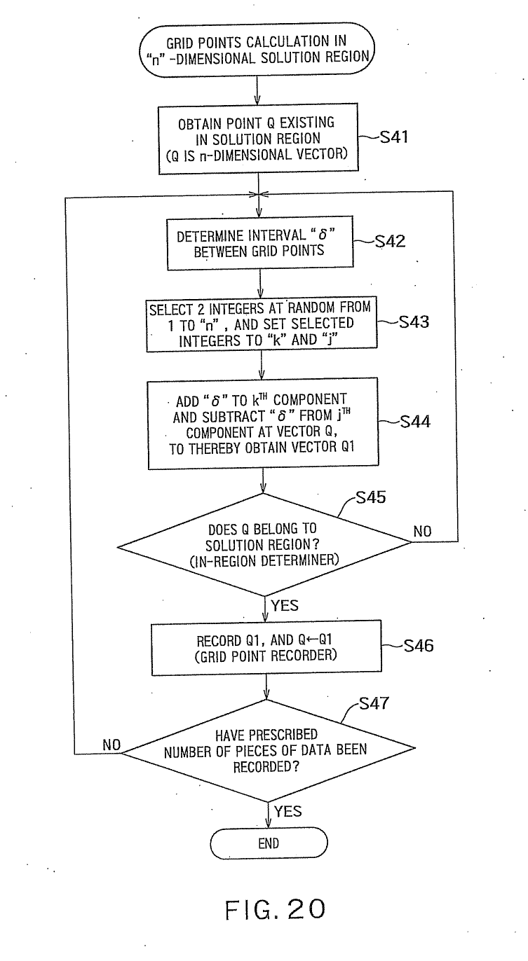

FIG. 19 and FIG. 20 are flow charts each illustrating an operation according to the present embodiment.

First, the solution region generator 21 previously calculates a solution region in a manner similar to that of Embodiment 1. Then, the enclosing sphere calculator 14 calculates a ball having the smallest radius, and the decomposition determiner 16 obtains a decomposition solution on the basis of the center of the ball in a manner similar to that of Embodiment 1. Note that the enclosing sphere calculator 14 may calculate the ball using a solution region filled by grid points, or may calculate the ball in completely the same manner as that of Embodiment 1.

In Step S31, grid points in the solution region are calculated. A detailed flow of Step S31 is illustrated in FIG. 20.

In Step S41 of FIG. 20, the grid point, generator 21a obtains a point Q (which may be designated by the user, or may be selected at random) existing in the solution region, determines an interval “δ” between the grid points (S42), and moves a point from the point Q at the determined interval using a random number (S43, S44).

If the in-region determiner 21b determines that a point Q1 at the move destination falls within the solution region (YES in S45), the grid point recorder 21c records therein the point Q1 at the move destination. Note that the point Q may be recorded in Step S41 by the grid point recorder 21c.

If the number of recorded points does not reach a predetermined number (or prescribed number) of points (NO in S47), the operation flow returns to Step S42. The prescribed number may be determined in accordance with, for example, the size of the solution region or the interval between the grid points, or may be designated by the user. Note that, in the interval determination in Step S42, the interval between the grid points may be set to the same value each time, or may be changed using a random number each time.

If it is determined in Step S45 that the point Q1 at the move destination does not fall within the solution region (NO in S45), the operation flow returns to Step S42. When the prescribed number of points is recorded, the flow of FIG. 20 is ended.

In Step S32 of FIG. 19, the region coverage function calculator 22 sets an initial value to the radius “r”.

In Step S33, a distance calculator 22a calculates a distance of each grid point in the solution region from a given central point (a solution coordinate obtained according to the method of Embodiment 1 or a solution coordinate obtained according to the proportional distribution based on upper boundary values).

In Step S34, a grid point counter 22b counts the number of grid points having a radius equal to or less than “r”.

In Step S35, the decomposition accuracy calculator 23 divides the number of grid points having a distance equal to or less than “r” by the total number of grid points in the solution region, to thereby obtain coverage “α”. Then, the decomposition accuracy calculator 23 plots (r, α). If “α” is less than 1.0, the decomposition accuracy calculator 23 increases “r” by a given value (S38), and the operation flow returns to Step S33. If “α” is equal to or more than 1.0, the operation flow is ended.

After this, the decomposition determiner 24 may perform the following processing.

A radius when the coverage has a predetermined value (for example, 90%) is determined for each of a first ball (a ball having its center at a solution obtained according to the method of Embodiment 1) and a second ball (a ball having its center at a solution obtained according to another given method such as the proportional distribution based on upper boundary values).

When the radius of the first ball is equal to or less than the radius of the second ball, a value of each element corresponding to the central coordinate of the first ball is determined as the quantity of consumed energy of each element. On the other hand, when the radius of the first ball is larger than the radius of the second ball, a value of each element corresponding to the coordinate obtained according to the given method is determined as the quantity of consumed energy of each element.

Note that the present embodiment may be applied to only a plurality of coordinates obtained according to a plurality of any given methods, and the central coordinate of the ball having the smallest radius do not necessarily need to be used.

In this way, according to Embodiment 2, a decomposed solution can be obtained without involving an extremely deviated decomposed solution.

### Embodiment 3

In Embodiment 2, the grid points in the region are created according to the Markov chain Monte Carlo method, whereby the coverage is calculated. In the present embodiment, description is given of an example in which the coverage is calculated through approximation by way of a line segment from a decomposed point to each vertex of a solution region.

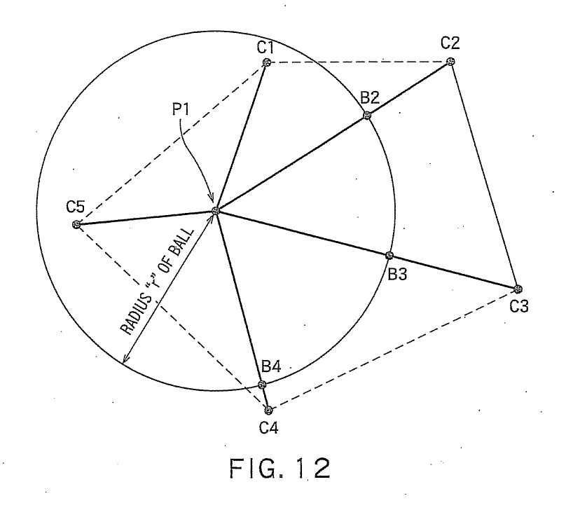

FIG. 12 illustrates line segments connecting vertexes C1 to C5 of the solution region illustrated in FIG. 6(A) to the decomposed point P1.

The length of a line segment connecting the point P1 to a point Ci is represented by d(P1, Ci).

Assuming that the total length of all the line segments is “L”, the following expression is established.

L=d(P1,C1)+d(P1,C2)+d(P1,C3)+d(P1,C4)+d(P1,C5)

For a ball having its center at the point P1 and having the radius “r” as illustrated in FIG. 12, the length of a portion of each line segment enclosed in the ball is represented by d1(P1, Ci, r). Then, d1(P1, Ci, r) is calculated by the following expression. That is, if the line segment is equal to or more than the radius, d1(P1, Ci, r) is coincident with the length of the radius. If the line segment is less than the length of the radius, d1(P1, Ci, r) is coincident with the length of the line segment.

$$d 1 ( P 1 , Ci , r ) = \{ \begin{matrix}r & ( r \leq d ( P 1 , Ci ) ) \\ d ( P 1 , Ci ) & ( r > Ld ( P 1 , Ci ) )\end{matrix}$$

Then, the coverage is calculated by the following expression.

$$\frac{{\sum }_{i = 1}^{5} d 1 ( P 1 , Ci , r )}{L}$$

In the example of FIG. 12, for line segments P1-C1 and P1-C5, the entire line segments are enclosed in the ball having the radius “r”, and for line segments P1-C2, P1-C3, and P1-C4, the lengths thereof from P1 to respective points B2, B3, and B4 intersecting with the ball surface are enclosed in the ball.

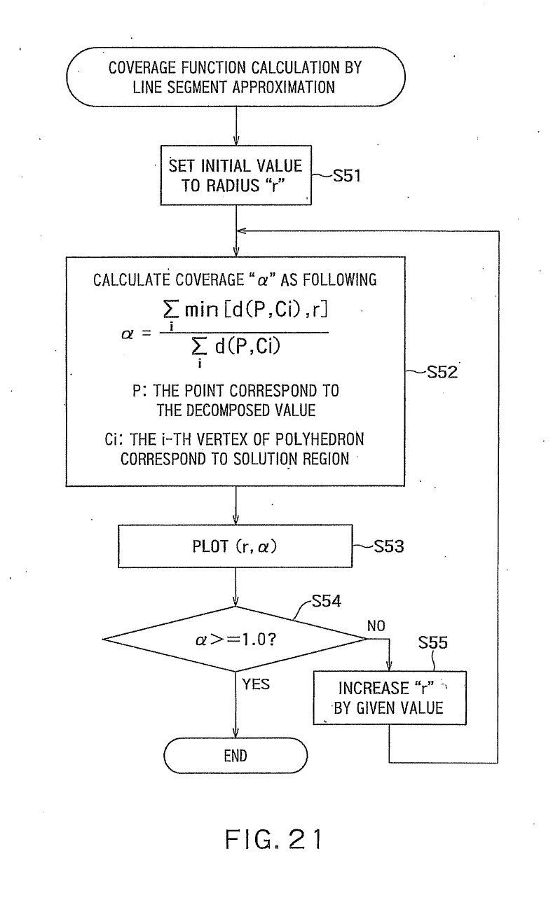

FIG. 21 illustrates a processing flow according to Embodiment 3.

Steps S33 to S35 of FIG. 19 are changed to Step S52, and Steps S51 and S53 to S55 are the same as Steps S32 and S36 to S38 of FIG. 19.

In Step S52 of FIG. 21, the coverage is calculated on the basis of a ratio of: the total length of portions of the line segments enclosed in the solution region; to the total length of the line segments from the given center P to the respective vertexes of the solution region.

For example, the coverage to the first ball (the ball that is obtained according to the method of Embodiment 1 and has the smallest radius) is obtained by calculating a ratio of: the total length of portions of the line segments enclosed in the solution region; to the total length of the line segments from the center of the first ball to the respective vertexes of the solution region.

Similarly, the coverage to the second ball (the ball having its center at the solution obtained according to another given method such as the proportional distribution based on upper boundary values) is obtained by calculating a ratio of: the total length of portions of the line segments enclosed in the solution region; to the total length of the line segments from the center of the second ball to the respective vertexes of the solution region.

In this way, according to the present embodiment, the coverage can be calculated with a smaller amount of calculation.

### Embodiment 4

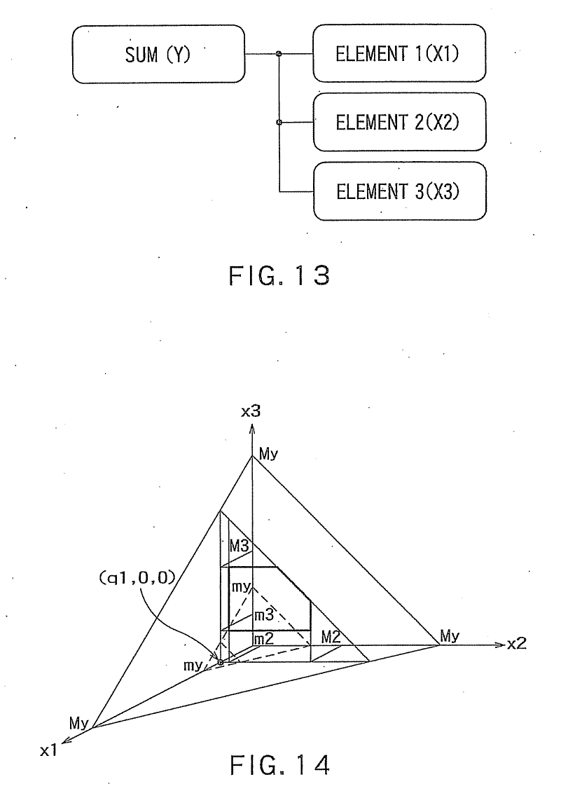

In FIG. 1(A), the measurement value of the measuring apparatus (electric energy meter) is distributed to the devices X, Y, and Z. In the present embodiment, description is given of the case where, in a connection configuration of FIG. 13, the consumed energy of an element 1 has been measured and only ranges of the upper bounds and lower bounds of an element 2, an element 3, and a sum (for example, a value of a measuring apparatus) are known. Note that the element 1 is a measuring apparatus, and the elements 2 and 3 are a device or a measuring apparatus.

It is assumed that a measurement value of the element 1 is “q1”, the respective lower bounds of the element 2 and the element 3 are “m2” and “m3”, the respective upper bounds thereof are “M2” and “M3”, and the lower bound and the upper bound of the sum are “my” and “My”. At this time, a region defined by the following expressions corresponds to a possible range of a decomposed solution. “x2” and “x3”, which are variables, respectively represent the decomposed values of the element 2 and the element 3.

my≦q1+x2+x3≦My

m2≦x2≦M2

m3≦x3≦M3

The region defined by these expressions corresponds to a planar region surrounded by thick lines of FIG. 14.

The center of the smallest enclosing circle of this region can be determined as the decomposed values of “x2”, “x3”, and “y”, and the coverage can also be calculated.

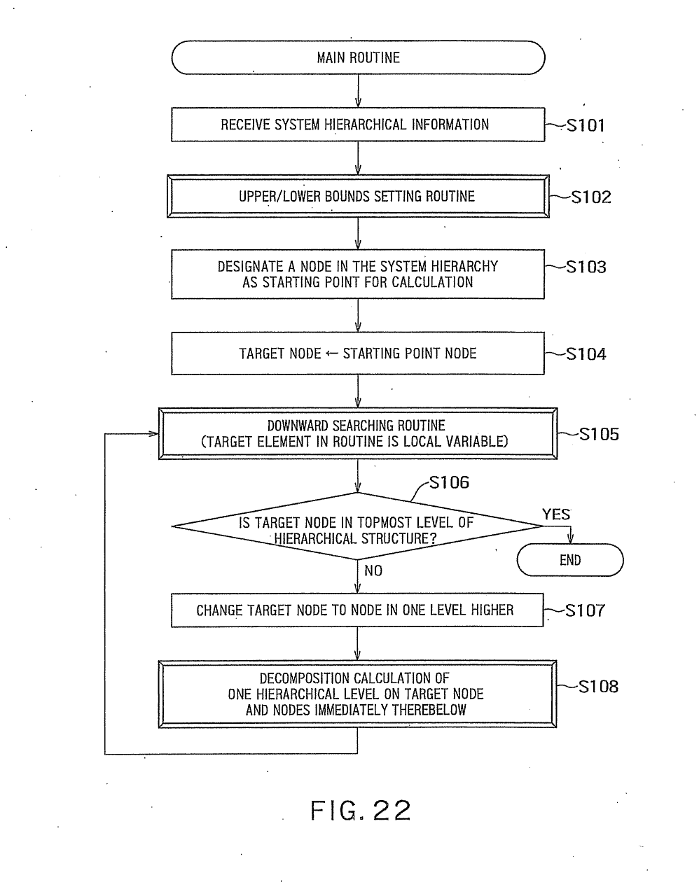

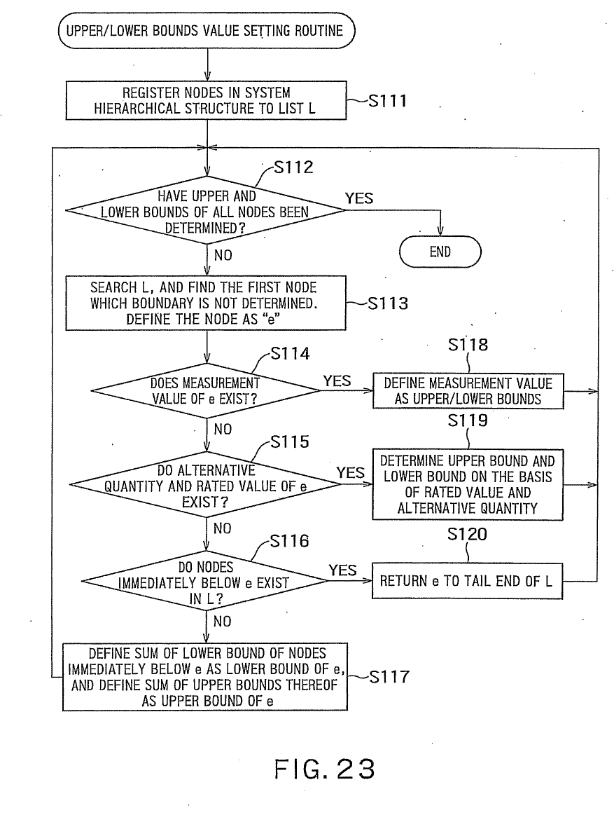

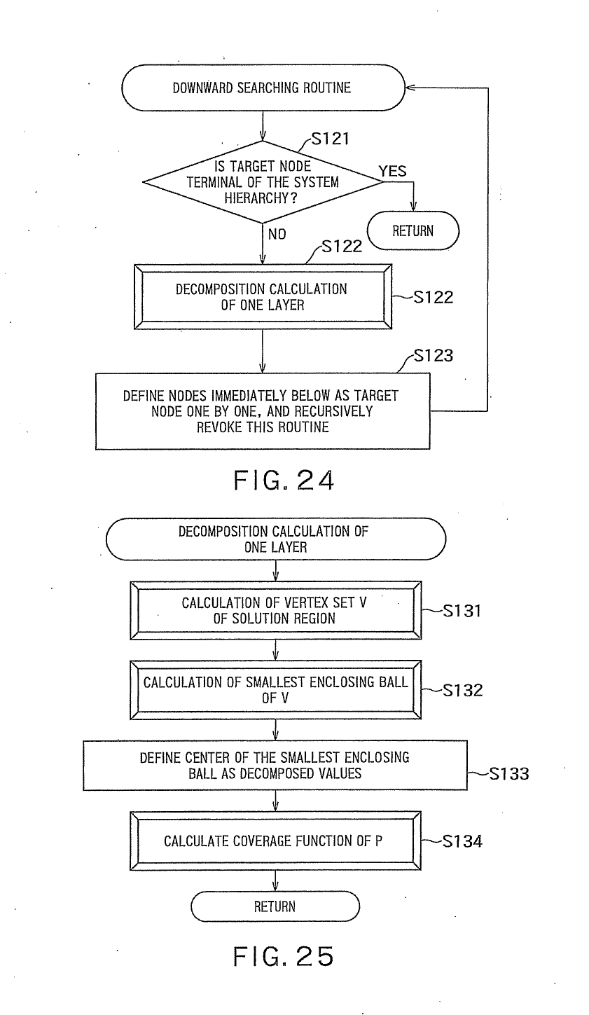

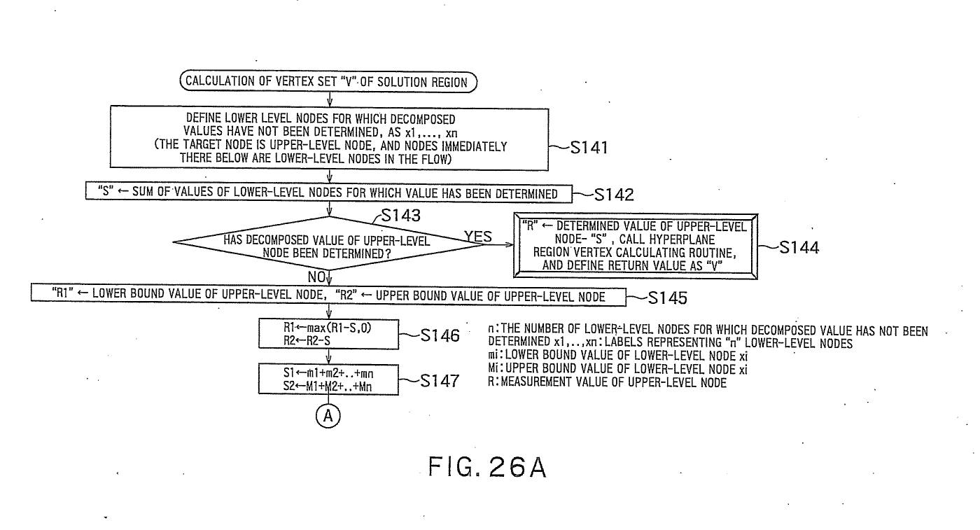

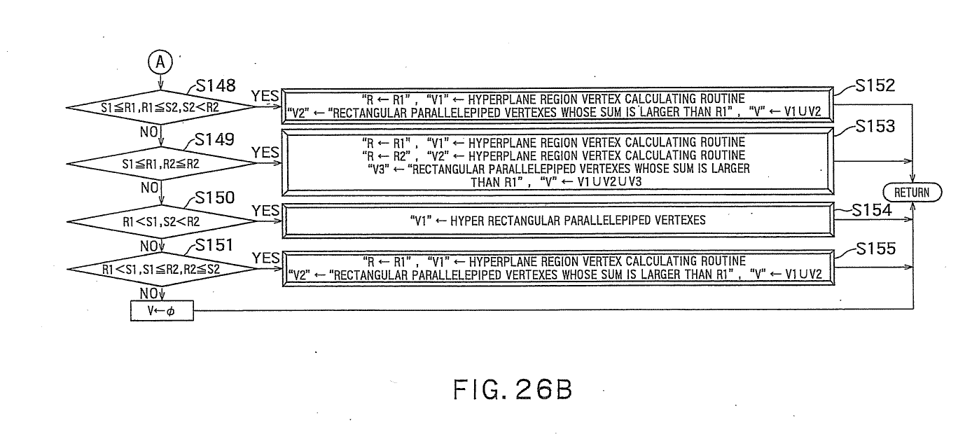

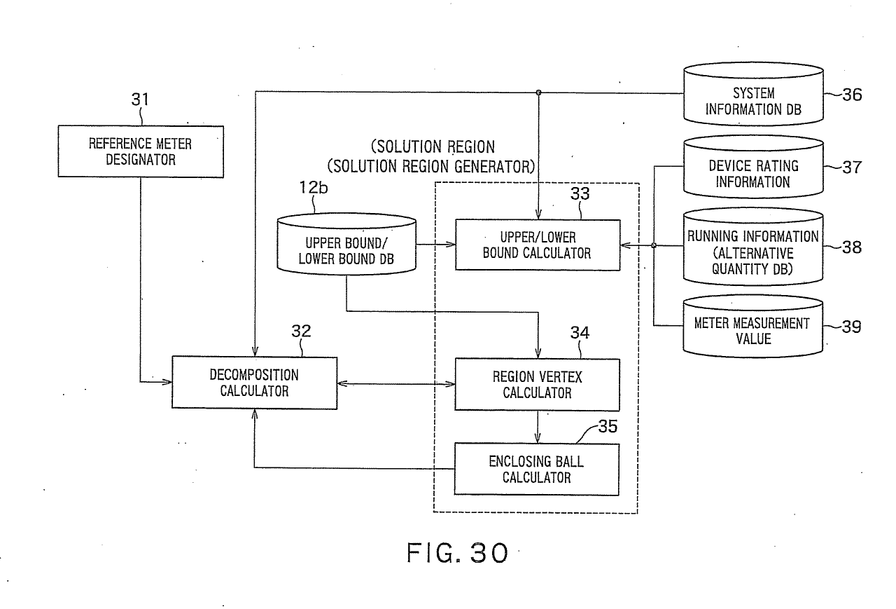

Even if the hierarchical configuration has three or more hierarchical levels (see FIG. 1(B)), decomposition calculation can be implemented at a given point by repeating the above-mentioned processing. Specific procedures of the processing at this time are illustrated in FIG. 22, FIG. 23, FIG. 24, FIG. 25, FIGS. 26A and 26B, FIG. 27, FIG. 28, and FIG. 29. In addition, a block diagram according to the present embodiment is illustrated in FIG. 30.

FIG. 22 illustrates a main routine, and FIG. 23 to FIG. 29 each illustrate a subroutine.

A basic flow of this processing is described.

In the hierarchical structure, one of a plurality of measuring apparatuses is designated as a starting point.

Assuming that the consumed energy of the measuring apparatus designated as the starting point is a measurement value of this measuring apparatus, the hierarchical structure is searched downward, and decomposition division calculation is performed level by level. That is, the quantity of consumed energy of each lower-level element of the measuring apparatus as the starting point is obtained using the method of Embodiment 1 or the like.

In decomposition calculation of one hierarchical level, the decomposition calculation can be performed assuming that a measurement value (determined value) of a measuring apparatus other than the measuring apparatus designated as the starting point (or a new starting point described below) has a given allowance (±δ), considering a measurement error. As a result, for example, even if all lower-level elements of the measuring apparatus are measuring apparatuses, the consumed energy (measurement value) of each lower-level element can be appropriately determined.

If a measuring apparatus exists among the lower nodes, this measuring apparatus is designated as a new starting point, and the hierarchical structure is searched downward. That is, assuming that the consumed energy of the measuring apparatus newly designated as the starting point is the consumed energy obtained as described above, the quantity of consumed energy of each lower-level element of this measuring apparatus is obtained.

If an upper node of the measuring apparatus as the starting point exists, the hierarchical structure is searched upward. That is, assuming that the consumed energy of the measuring apparatus designated as the starting point is a measurement value of this measuring apparatus, the consumed energies of the upper node and other lower nodes of this upper node are obtained. If a measuring apparatus exists among the other lower nodes, this measuring apparatus is designated as a new starting point, the hierarchical structure is searched downward similarly to the above, and decomposition calculation is performed level by level.

If an upper node of the upper node of the measuring apparatus as the starting point further exists, the upward searching described above is repeatedly performed until a topmost element in the hierarchical structure is reached.

In this way, with reference to the measuring apparatus that is first designated as the starting point, the hierarchical structure is repeatedly searched downward and upward, whereby the consumed energy of each element in the hierarchical structure can be obtained compatibly with the measurement value of the measuring apparatus as the starting point. The detail of this processing is described below.

In S101 of FIG. 22, system hierarchical information (a connection relation of measuring apparatuses and devices) is received.

In Step S102, the upper and lower boundary values of each node are determined according to a flow (S111 to S120) of FIG. 23. In the flow of FIG. 23, the upper and lower bounds are set for each node. This is achieved by an upper/lower bound calculator 33 by means of device rating information 37, running information (alternative quantity DB) 38, and a meter measurement value 39. The device rating information 37 contains a rated value of each node. The running information 38 contains running hours and power consumption of each node. The meter measurement value 39 is a measurement value of the measuring apparatus. The upper and lower boundary values are stored in an upper bound/lower bound DB.

In Step S103, an element as a starting point (reference meter) is designated by a reference meter designator 31. In Step S104, the designated node is defined as a target element.

In Step S105, the hierarchical structure is searched downward from the target node. This routine is illustrated in FIG. 24. In the downward searching of FIG. 24, decomposition calculation on the target node and a level immediately below the target node (decomposition calculation of one hierarchical level) is repeated by a decomposition calculator 32, a region vertex calculator 34, and an enclosing sphere calculator 35 until the bottommost level is reached. A detailed flow of this decomposition calculation is illustrated in a flow (S131 to S134) of FIG. 25.

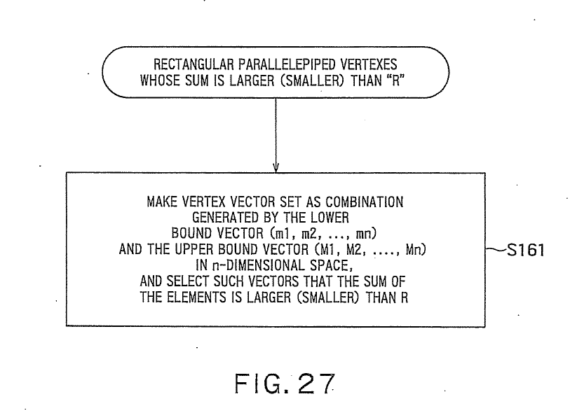

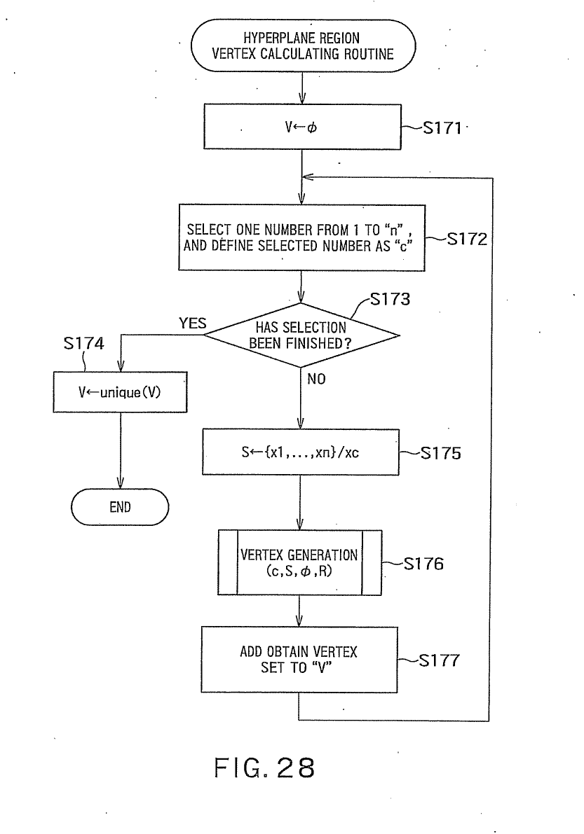

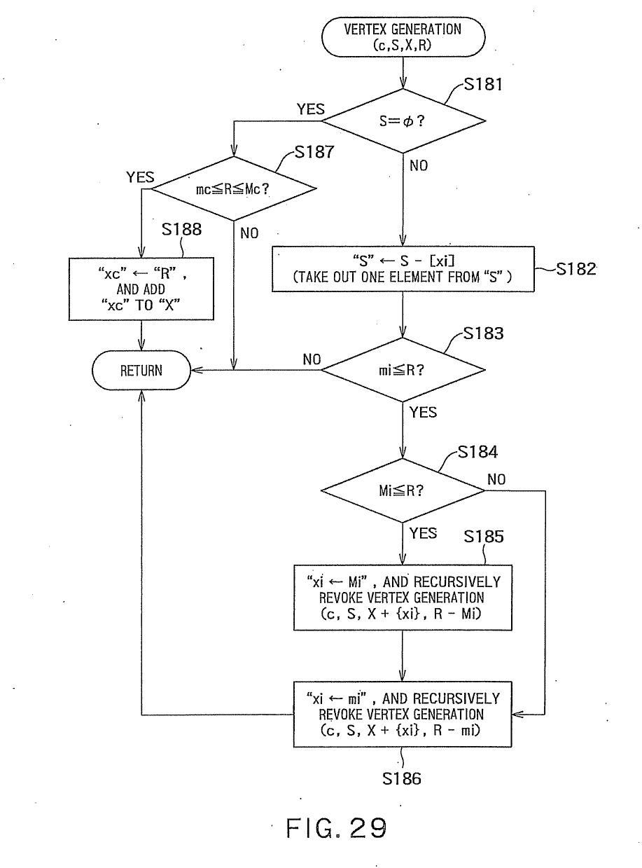

In the flow of FIG. 25, a vertex set of a solution region is first calculated (S131). The detail of this calculation flow is illustrated in a flow (S141 to S155) of FIGS. 26A and 26B. In Step S144 of FIG. 26A, a flow (S171 to S177) of FIG. 28 is invoked. In Steps S152 to S155 of FIG. 26B, a flow (S161) of FIG. 27 is invoked. In addition, in S176 of the flow of FIG. 28, a flow (S181 to S188) of FIG. 29 is invoked. Detailed operations of each processing are as illustrated in each flow chart.

After the vertex set of the solution region is calculated in this way, the smallest enclosing ball of the vertex set of the solution region is then calculated (S132). The detail thereof is as described in the above embodiments. The center of the smallest enclosing ball is defined as a decomposition solution (S133). This estimation result is defined as an estimation value for one hierarchical level. In Step S134, the coverage function is calculated. The method of calculating the coverage function is also as described in the above embodiments.

Returning to the main routine of FIG. 22, if the target node is in the topmost level (YES in S106), this processing is ended. If the target node is not in the topmost level (NO in S106), the target node is changed to an element in one level higher (S107), and decomposition calculation of one hierarchical level (FIG. 25) is performed on the target node after the change and elements immediately below the target nodet (S108).

### Embodiment 5

In the present embodiment, approximate calculation of a decomposed value and a coverage function is described.

Vertexes of a solution region need to be obtained for calculation of the smallest enclosing sphere. A solution region that is a convex polyhedron in an “n”-dimensional space has a number of vertexes, the number being in an exponent level of “n”. Hence, as “n” is larger, the amount of calculation increases more.

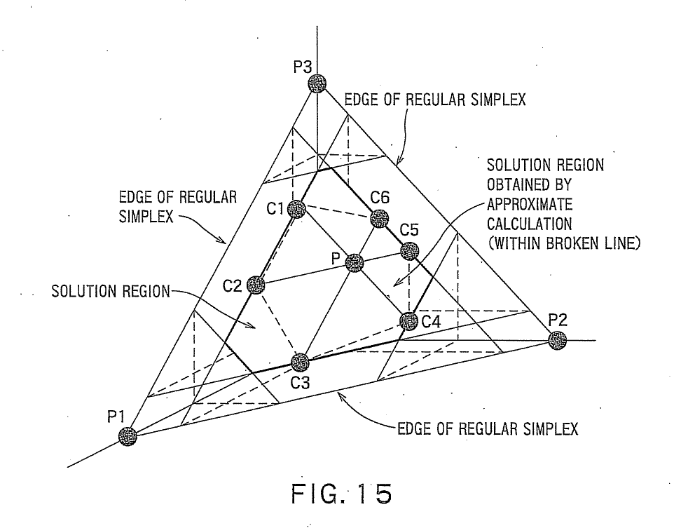

In view of the above, as illustrated in FIG. 15, the solution region and the coverage function may be approximately calculated using line segments P-C1, P-C2, P-C3, P-C4, P-C5, and P-C6 that are parallel to sides of a regular simplex, instead of the decomposed point and the vertexes of the solution region as illustrated in FIG. 12.

A region surrounded by thick lines in FIG. 15 is an originally correct solution region, but in the present embodiment, a region surrounded by six points C1 to C6 is defined as the solution region for approximate calculation.

For example, C1 is one of the points C1 and C4 at which a straight line that is parallel to an edge P2-P3 of the regular simplex and passes through the decomposed point P intersects with a boundary of the correct solution region.

The number of edges of the n-dimensional regular simplex is n(n−1)/2, and hence the number of intersection points between: straight lines that are parallel to all the edges and pass through P; and the boundary of the solution region is n(n−1). Accordingly, the number of points, which increases exponentially with n in case of the original solution region, can be suppressed to second order, so that the amounts of calculation of the solution region and the coverage can be reduced.

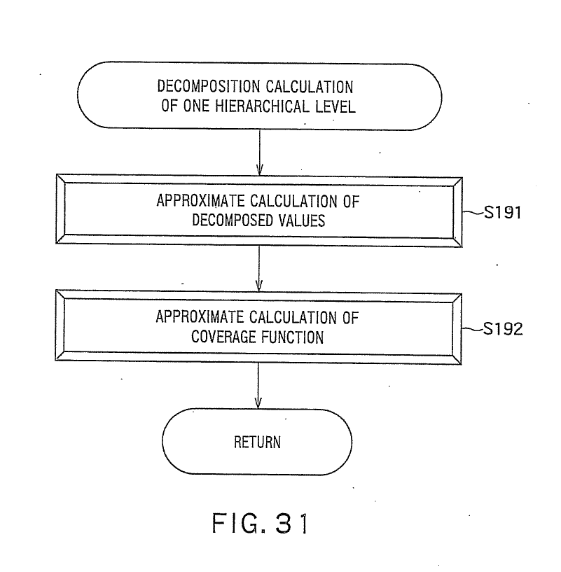

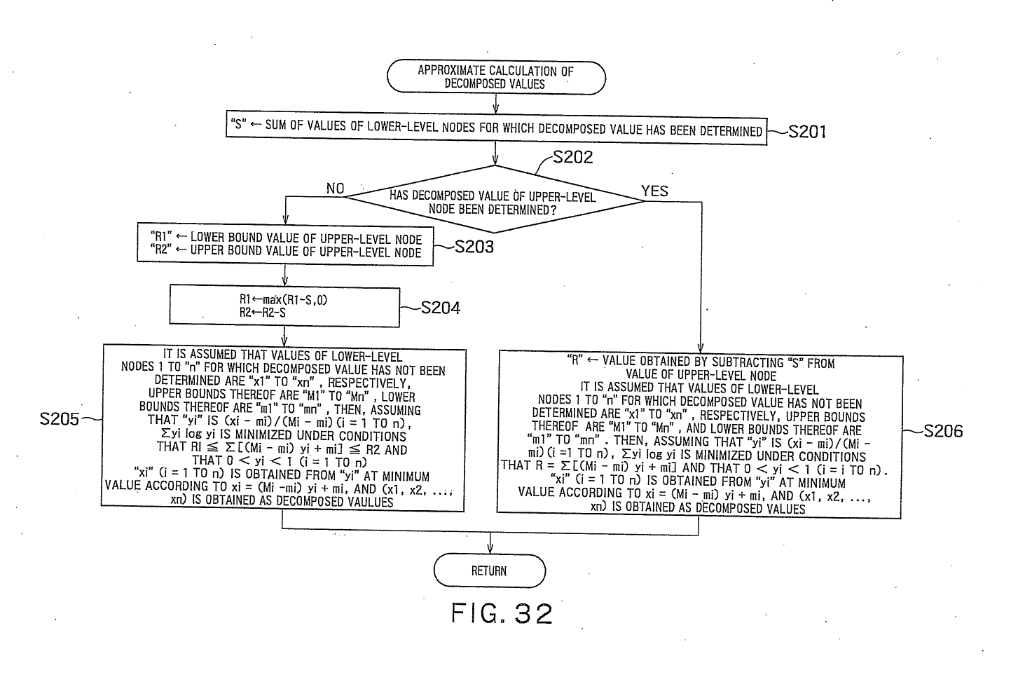

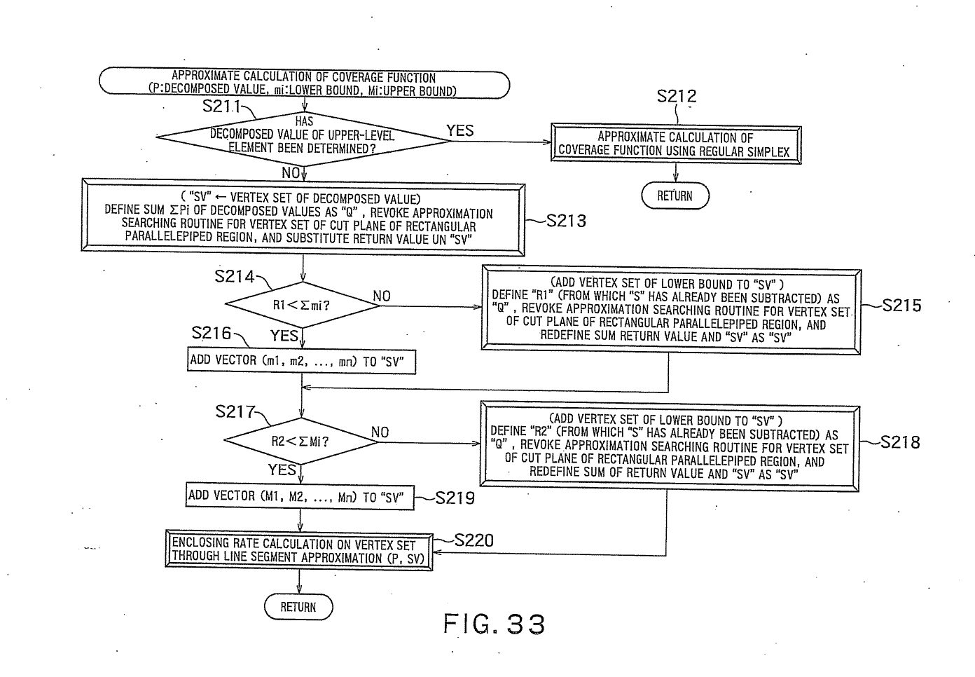

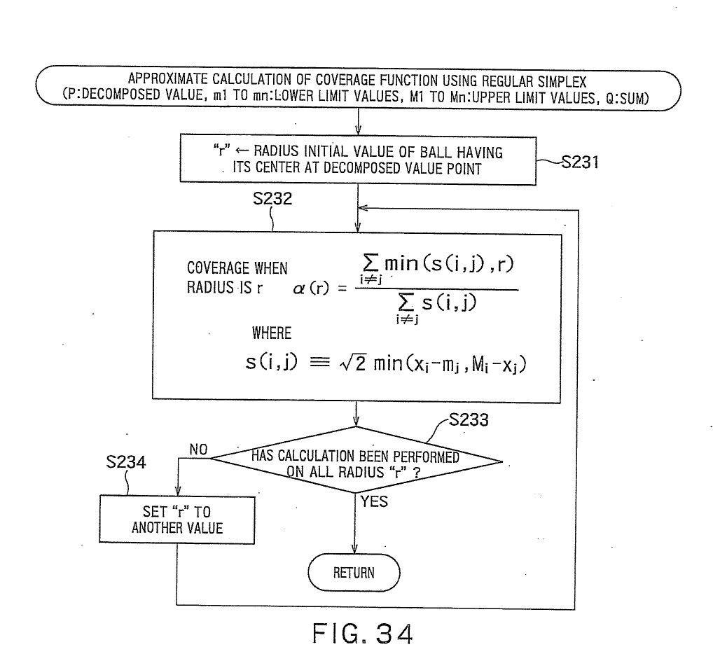

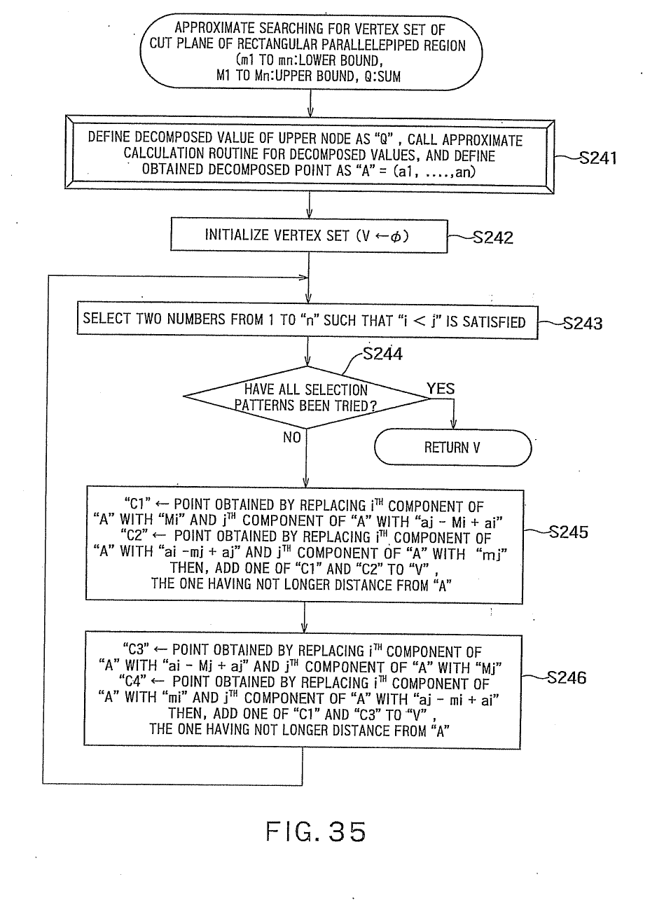

A processing flow at this time is illustrated in FIG. 31. In the case where the present embodiment is incorporated in Embodiment 4, it is sufficient to replace “DECOMPOSITION CALCULATION OF ONE HIERARCHICAL LEVEL” of FIG. 25 with FIG. 31. In Step S191 of FIG. 31, the decomposition solution is approximately calculated, and a detailed flow thereof is as illustrated in a flow (S201 to S206) of FIG. 32. In Step S192 of FIG. 31, the coverage function is approximately calculated, and a detailed flow thereof is as illustrated in a flow (S211 to S220) of FIG. 33. In Step S212 of FIG. 33, a flow (S231 to S234) of FIG. 34 is invoked. In Steps S213, S215, and S218 of FIG. 33, a flow (S241 to S246) of FIG. 35 is invoked. Detailed operations of each processing are as illustrated in each flow chart.

In this way, according to the present embodiment, the amounts of calculation of the solution region and the coverage function can be reduced.

The decomposition calculating apparatus may also be realized using a general-purpose computer device as basic hardware. That is, the elements of the apparatus can be realized by causing a processor mounted in the above described computer device to execute a program. In this case, the apparatus may be realized by installing the above described program in the computer device beforehand or may be realized by storing the program in a storage medium such as a CD-ROM or distributing the above described program over a network and installing this program in the computer device as appropriate. Furthermore, the storage in the apparatus may also be realized using a memory device or hard disk incorporated in or externally added to the above described computer device or a storage medium such as CD-R, CD-RW, DVD-RAM, DVD-R as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A decomposition calculating apparatus comprising:
a first storage configured to store therein a connection configuration of a plurality of elements in an electric power system;
a second storage configured to store therein possible ranges of respective quantities of consumed energy by the elements;
a solution region generator configured to develop the ranges of the quantities of consumed energy, in a space formed by axes indicative of the respective quantities of consumed energy of the elements and obtain a solution region being a region common to the ranges of the quantities of consumed energy in the space;
an enclosing ball calculator configured to obtain a ball that encloses the solution region and has a smallest radius and acquire a central coordinate of the ball; and
a decomposition determiner configured to determine quantities of consumed energy of the elements to values of the axes corresponding to the central coordinate in the space.

2. A decomposition calculating apparatus comprising:
a first storage configured to store therein a connection configuration of a plurality of elements in an electric power system;
a second storage configured to store therein possible ranges of respective quantities of consumed energy by the elements;
a solution region generator configured to develop the ranges of the quantities of consumed energy, in a space formed by axes indicative of the respective quantities of consumed energy of the elements and obtain a solution region being a region common to the ranges of the quantities of consumed energy in the space;
a covering relation calculator configured to calculate a graph showing a relation between: a radius of a ball having its center at a given coordinate; and coverage indicative of a proportion of a portion of the solution region covered by the ball; and
a decomposition determiner, wherein:
the solution region generator sets, in the space, a plurality of coordinates each indicative of a candidate of the respective quantities of consumed energy by the elements;
the covering relation calculator calculates, for each of the coordinates, a graph showing a relation between: a radius of a ball having its center at the coordinate; and coverage, indicative of a proportion of a portion of the solution region covered by the ball; and
the decomposition determiner specifies, for each graph, a radius corresponding to coverage of a predetermined value, and determines quantities of consumed energy of the elements to values of the axes specified by one of the coordinates corresponding to the graph giving a smallest radius.

3. A decomposition calculating apparatus according to claim 2, wherein
the covering relation calculator calculates the coverage on a basis of a ratio of a first total length to a second total length, the second total length being a total length of line segments from the center of the ball to respective vertexes of the solution region, and the first total length being a total length of portions of the line segments enclosed by the solution region.

4. The apparatus according to claim 1, wherein:
as the connection configuration of the elements, a plurality of measuring apparatuses are hierarchically connected, and each of lower-level elements of the measuring apparatuses is a measuring apparatuses or a device;
the decomposition calculating apparatus further comprises a reference meter designator configured to designate one of the measuring apparatuses as a starting point;
(A) consumed energy of the measuring apparatus designated as the starting point is determined to be a measurement value of this measuring apparatus, a quantity of consumed energy of each lower-level element of the measuring apparatus is determined based on the measurement value of the measuring apparatus, and if a measuring apparatus exists among the lower-level elements, this measuring apparatus is designated as a new starting point;
(B) consumed energy of the measuring apparatus newly designated as the starting point is determined to be consumed energy determined for this measuring apparatus, and a quantity of consumed energy of each lower-level element of this measuring apparatus is obtained based on the consumed energy of the measuring apparatus;
(C) if an upper-level element of the measuring apparatus as the starting point exists, consumed energies of the upper-level element and other lower-level elements of the upper-level element are determined based on the measurement value of the measuring apparatus, and, if a measuring apparatus exists among the other lower-level elements, this measuring apparatus is designated as a new starting point, and then the process (B) is performed; and
(D) if an upper-level element of the upper-level element of the measuring apparatus as the starting point further exists,
(C) is repeatedly performed until a topmost element in a hierarchical structure is reached.

5. A decomposition calculating method, comprising:
reading out a connection configuration of a plurality of elements in an electric power system from a first storage;
reading possible ranges of respective quantities of consumed energy by the elements from a second storage;
developing the ranges of the quantities of consumed energy, in a space formed by axes indicative of the respective quantities of consumed energy of the elements and obtaining a solution region being a region common to the ranges of the quantities of consumed energy in the space;
obtaining a ball that encloses the solution region and has a smallest radius and acquire a central coordinate of the ball; and
determining quantities of consumed energy by the element to values of the axes corresponding to the central coordinate in the space.

6. A non-transitory computer readable medium storing a program which, when executed by a computer, causes the computer to execute instructions to perform steps comprising:
reading out a connection configuration of a plurality of elements in an electric power system from a first storage;
reading possible ranges of respective quantities of consumed energy by the elements from a second storage;
developing the ranges of the quantities of consumed energy, in a space formed by axes indicative of the respective quantities of consumed energy of the elements and obtaining a solution region being a region common to the ranges of the quantities of consumed energy in the space;
obtaining a ball that encloses the solution region and has a smallest radius and acquire a central coordinate of the ball; and
determining quantities of consumed energy by the element to values of the axes corresponding to the central coordinate in the space.
